(19) United States
(12) Patent Application Publication
(10) Pub. No.: US 2016/0227574 A1
(43) Pub. Date: Aug. 4, 2016

(54) OPPORTUNISTIC UTILIZATION AND MITIGATION OF UNUSED UPLINK GRANTS IN WIRELESS COMMUNICATIONS

(71) Applicant: QUALCOMM Incorporated, San Diego, CA (US)

(72) Inventors: Ashwini RAINA, San Diego, CA (US); Gang Andy Xiao, San Diego, CA (US); Mohan Krishna Gowda, San Diego, CA (US)

(21) Appl. No.: 14/612,004

(22) Filed: Feb. 2, 2015

(51) Int. Cl. H04W 72/14; H04W 72/04

(52) U.S. Cl. CPC H04W 72/14; H04W 72/04

(57) ABSTRACT

Aspects disclosed herein relate to utilizing and/or mitigating superfluous resource grants in a wireless network. In one aspect, an uplink resource grant is received from a network node, and a plurality of protocol data units are mapped from a buffer over the uplink resource grant in generating a transport block for transmitting data. It is determined that additional resources remain on the uplink resource grant after mapping the protocol data units, and one or more additional protocol data units are mapped for opportunistically transmitting data from a best effort buffer over the additional resources. In another aspect, a maximum grant size for a user equipment (UE) is computed based at least in part on a modulation and coding scheme and a number of resource blocks configured for the UE, and used along with a priority of a bearer to determine whether to send a buffer status report for the bearer.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of a telecommunication standard is Long Term Evolution (LTE). LTE is a set of enhancements to the Universal Mobile Telecommunications System (UMTS) mobile standard promulgated by Third Generation Partnership Project (3GPP). Generally, a wireless multiple-access communication system can simultaneously support communication for multiple wireless terminals (e.g., user equipment (UE)), each of which can communicate with one or more base stations over downlink or uplink resources where the base stations can generate resource grants for the downlink or uplink resources for communicating to the wireless terminals.

There are instances where uplink transport blocks are partially or completely padded by a media access control (MAC) layer at a wireless terminal. Such instances can include the base station providing superfluous grants to the mobile terminal in response to buffer status reporting from the mobile terminal, the base station providing grants to the mobile terminal over a period of time (even when a buffer status report is 0) to avoid a new scheduling request transmitted by the mobile terminal, the base station continuously granting resources to the mobile terminal where the mobile terminal may not have data to transmit, the mobile terminal discarding time critical upper layer data due to a delay in the grant provided to the mobile terminal, etc. In such scenarios, the mobile terminal is allocated resources for uplink communications that oftentimes are unused.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an example, a method for utilizing available space in an uplink resource grant is provided. The method includes receiving an uplink resource grant from a network node, and mapping a plurality of protocol data units from a buffer over the uplink resource grant in generating a transport block for transmitting data. The method further includes determining that additional resources remain on the uplink resource grant after mapping the protocol data units, mapping one or more additional protocol data units for opportunistically transmitting data from a best effort buffer over the additional resources, and transmitting the plurality of protocol data units and the one or more additional protocol data units based on the uplink resource grant.

In another example, an apparatus for utilizing available space in an uplink resource grant is provided. The apparatus includes a communicating component configured to receive an uplink resource grant from a network node, and a resource mapping component configured to map a plurality of protocol data units from a buffer over the uplink resource grant in generating a transport block for transmitting data. The apparatus further includes an additional resource determining component configured to determine that additional resources remain on the uplink resource grant after mapping the protocol data units, and an additional resource mapping component configured to map one or more additional protocol data units for opportunistically transmitting data from a best effort buffer over the additional resources, wherein the communicating component is further configured to transmit the plurality of protocol data units and the one or more additional protocol data units based on the uplink resource grant.

In yet another example, a method for sending buffer status reports (BSR) in wireless communications is provided. The method includes computing a maximum grant size for a user equipment (UE) based at least in part on a modulation and coding scheme and a number of resource blocks configured for the UE, determining a priority for a radio bearer, and sending a BSR for the radio bearer based at least in part on the maximum grant size and the priority for the radio bearer.

In another example, an apparatus for sending BSRs in wireless communications is provided including a maximum grant size computing component configured to compute a maximum grant size for a user UE based at least in part on a modulation and coding scheme and a number of resource blocks configured for the UE, a bearer categorizing component configured to determine a priority for a radio bearer, and a buffer status reporting component configured to send a BSR for the radio bearer based at least in part on the maximum grant size and the priority for the radio bearer.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram illustrating an example wireless communications system for utilizing unused resources in uplink resource grants;

FIG. 2 is a flow diagram comprising a plurality of functional blocks representing an example methodology for utilizing unused resources in uplink resource grants;

FIG. 3 is a block diagram illustrating an example wireless communications system for managing buffer status report transmission to mitigate superfluous grants;

FIG. 4 is a flow diagram comprising a plurality of functional blocks representing an example methodology for managing buffer status report transmission to mitigate superfluous grants;

FIG. 5 is a flow diagram comprising a plurality of functional blocks representing another example methodology for managing buffer status report transmission to mitigate superfluous grants;

FIG. 6 is a diagram illustrating an example of a hardware implementation for an apparatus employing a processing system; and

FIG. 7 is a diagram illustrating an example of an evolved Node B and user equipment in an access network.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts. Moreover, in an aspect, a component may be generally understood to be one of the parts that make up a system, may be hardware or software, and/or may be divided into other components.

Described herein are various aspects related to utilizing and/or mitigating unused resources of uplink grants for uplink communications. For example, the unused resources may result from certain scenarios, as described above, which may not be predictable. Thus, for example, the unused resources may be used for data that can accept a best effort quality of service (QoS). In one example, a device (e.g., user equipment (UE) or other network device) receiving an uplink resource grant for communicating with a network node may determine whether resources in the uplink resource grant remain after mapping protocol data units (PDU) to the resources, and if so, the device can utilize at least a portion of the remaining resources to send best effort QoS data. In one example, the device can create a best effort bearer over which the device can map remaining resources to data in a corresponding best effort buffer for communicating to the network node.

In another aspect described herein, superfluous grants from the network node may be avoided by controlling buffer status reporting by the device. For example, the device may classify radio bearers as having a priority based on a type of traffic transmitted over the bearers. The device may control when buffer status is reported based on the type of bearer to avoid superfluous grants. For example, the device may frequently transmit buffer status reports to the network node for high priority bearers. In another example, the device may compute a maximum possible grant value for lower priority bearers, and can send a buffer status report when a buffer related to the grant achieves a threshold computed as a proportion of the maximum possible grant value. The proportion may be based on the priority, for example, (e.g., ½ for a medium priority bearer, 1 for a low priority bearer, etc.). In addition, a timer can be maintained to ensure a buffer status report over such bearers is eventually communicated to the network node.

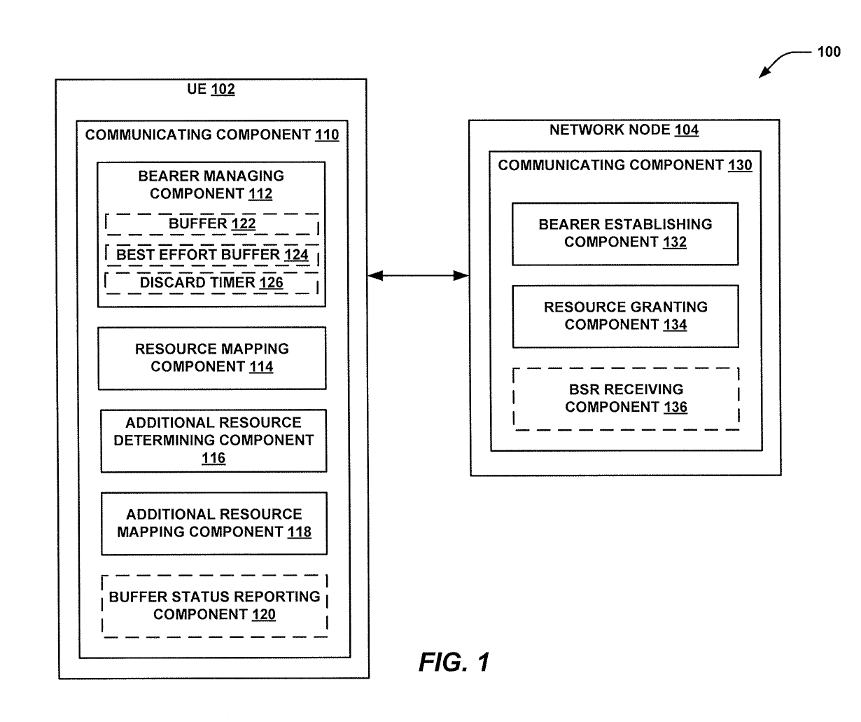

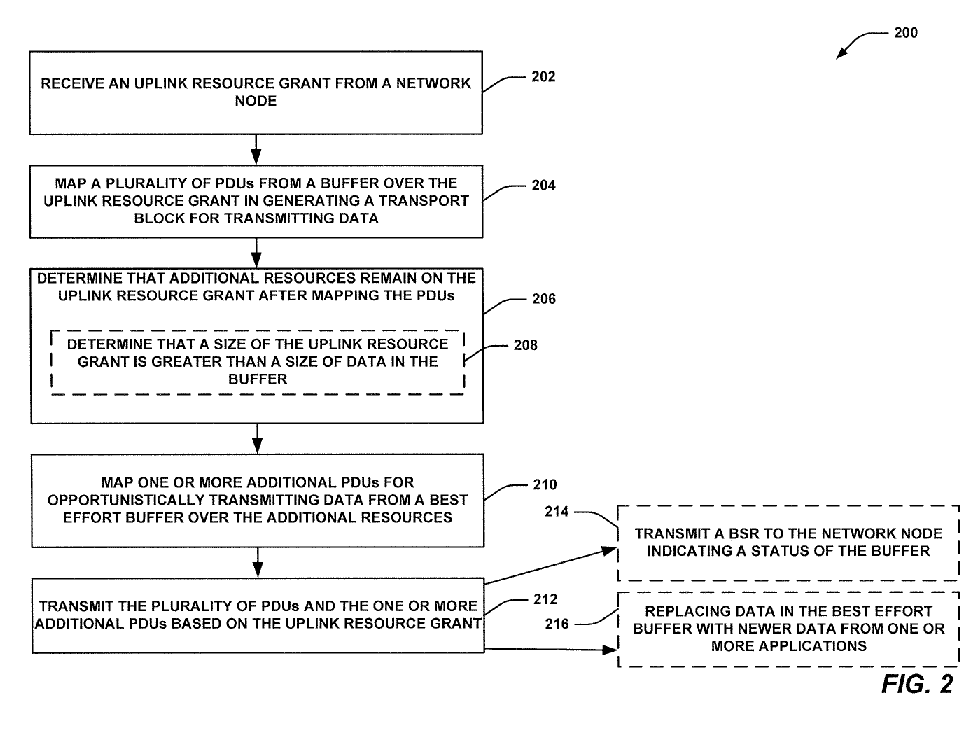

Referring to FIGS. 1-5, aspects are depicted with reference to one or more components and one or more methods that may perform the actions or functions described herein. Although the operations described below in FIGS. 2, 4, and 5 are presented in a particular order and/or as being performed by an example component, it should be understood that the ordering of the actions and the components performing the actions may be varied, depending on the implementation. Moreover, it should be understood that the following actions or functions may be performed by a specially-programmed processor, a processor executing specially-programmed software or computer-readable media, or by any other combination of a hardware component and/or a software component capable of performing the described actions or functions.

FIG. 1 is a schematic diagram illustrating a system 100 for wireless communication, according to an example configuration. FIG. 1 includes a UE 102 that receives resource grants from a network node 104 for communicating with the network node 104. Though one UE 102 and one network node 104 are shown, it is to be appreciated that multiple UEs 102 can communicate with a network node 104, a UE 102 can communicate with multiple network nodes 104, and/or the like. In addition, it is to be appreciated that UE 102 can be substantially any sort of network device that can receive resources for communicating with a network node 104. Similarly, network node 104 can be substantially any network node that generates resource grants for allowing one or more devices to communicate therewith.

UE 102 can include a communicating component 110 for managing communications with network node 104, which may include receiving resource grants from the network node 104 and communicating over the granted resources. Communicating component 110 can include a bearer managing component 112 for managing one or more radio bearers for communicating with a network node, a resource mapping component 114 for mapping data from a buffer of the one or more radio bearers to resources granted by the network node, and additional resource determining component 116 for determining whether resources remain after mapping the data to the resources granted by the network node, and an additional resource mapping component 118 for mapping data from another buffer to the additional remaining resources. Communicating component 110 may optionally include a buffer status reporting component 120 for communicating a buffer status report (BSR) for one or more of the radio bearers to the network node.

Network node 104 can also include a communicating component 130 for granting resources to one or more UEs for communicating with network node 104. Communicating component 130 can include a bearer establishing component 132 for establishing one or more radio bearers with the one or more UEs for communicating therewith, and a resource granting component 134 for granting resources over which the one or more UEs can communicate with the network node 104 using the one or more radio bearers. Communicating component 130 may optionally include a BSR receiving component 136 for receiving a BSR relating to buffers of the one or more radio bearers, based on which the resource granting component 134 can grant resources to the one or more UEs.

UE 102 may comprise any type of mobile device, such as, but not limited to, a smartphone, cellular telephone, mobile phone, laptop computer, tablet computer, or other portable networked device that can be a standalone device, tethered to another device (e.g., a modem connected to a computer), a watch, a personal digital assistant, a personal monitoring device, a machine monitoring device, a machine to machine communication device, etc. In addition, a UE may also be referred to by those skilled in the art as a mobile station, a subscriber station, a mobile unit, a subscriber unit, a wireless unit, a remote unit, a mobile device, a mobile communications device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In general, a UE may be small and light enough to be considered portable and may be configured to communicate wirelessly via an over-the-air communication link using one or more OTA communication protocols described herein. Additionally, in some examples, a UE may be configured to facilitate communication on multiple separate networks via multiple separate subscriptions, multiple radio links, and/or the like.

Furthermore, network node 104 may comprise one or more of any type of network module, such as an access point, a macro cell, including a base station (BS), node B, eNodeB (eNB), a relay, a peer-to-peer device, an authentication, authorization and accounting (AAA) server, a mobile switching center (MSC), a mobility management entity (MME), a radio network controller (RNC), a small cell, etc. As used herein, the term “small cell” may refer to an access point or to a corresponding coverage area of the access point, where the access point in this case has a relatively low transmit power or relatively small coverage as compared to, for example, the transmit power or coverage area of a macro network access point or macro cell. For instance, a macro cell may cover a relatively large geographic area, such as, but not limited to, several kilometers in radius. In contrast, a small cell may cover a relatively small geographic area, such as, but not limited to, a home, a building, or a floor of a building. As such, a small cell may include, but is not limited to, an apparatus such as a BS, an access point, a femto node, a femtocell, a pico node, a micro node, a Node B, eNB, home Node B (HNB) or home evolved Node B (HeNB). Therefore, the term “small cell,” as used herein, refers to a relatively low transmit power and/or a relatively small coverage area cell as compared to a macro cell. Additionally, a network node may communicate with one or more other network node of wireless and/or core networks

Additionally, system 100 may include any network type, such as, but not limited to, wide-area networks (WAN), wireless networks (e.g. 802.11 or cellular network), the Public Switched Telephone Network (PSTN) network, ad hoc networks, personal area networks (e.g. Bluetooth®) or other combinations or permutations of network protocols and network types. Such network(s) may include a single local area network (LAN) or wide-area network (WAN), or combinations of LANs or WANs, such as the Internet. Such networks may comprise a Wideband Code Division Multiple Access (W-CDMA) system, and may communicate with one or more UEs according to this standard. As those skilled in the art will readily appreciate, various aspects described herein may be extended to other telecommunication systems, network architectures and communication standards. By way of example, various aspects may be extended to other Universal Mobile Telecommunications System (UMTS) systems such as Time Division Synchronous Code Division Multiple Access (TD-SCDMA), High Speed Downlink Packet Access (HSDPA), High Speed Uplink Packet Access (HSUPA), High Speed Packet Access Plus (HSPA+) and Time-Division CDMA (TD-CDMA). Various aspects may also be extended to systems employing Long Term Evolution (LTE) (in frequency division duplexing (FDD), time division duplexing (TDD), or both modes), LTE-Advanced (LTE-A) (in FDD, TDD, or both modes), CDMA2000, Evolution-Data Optimized (EV-DO), Ultra Mobile Broadband (UMB), Institute of Electrical and Electronics Engineers (IEEE) 802.11 (Wi-Fi), IEEE 802.16 (WiMAX®), IEEE 802.20, Ultra-Wideband (UWB), Bluetooth, and/or other suitable systems. The actual telecommunication standard, network architecture, and/or communication standard employed will depend on the specific application and the overall design constraints imposed on the system. The various devices coupled to the network(s) (e.g., UE 102 and/or network node 104) may be coupled to a core network via one or more wired or wireless connections.

FIG. 2 illustrates a method 200 for utilizing unused resources from resource grants received from a network node. Method 200 includes, at Block 202, receiving an uplink resource grant from a network node. Communicating component 110 can receive the uplink resource grant from the network node 104. For example, the uplink resource grant may correspond to a physical uplink shared channel (PUSCH) or similar grant over which the UE 102 can transmit communications to the network node 104. For example, the uplink resource grant may correspond to a plurality of resource blocks in an OFDM symbol over which the UE 102 can map data for transmission to the network node 104.

For example, UE 102 and network node 104 can establish communications for the control channel, shared channel, etc. communications over one or more radio bearers. For example, bearer managing component 112 may establish one or more bearers with network node 104, and thus bearer establishing component 132 can participate in establishing the one or more bearers. In an example, UE 102 may include buffers 122 for each of the one or more bearers, where the buffers store PDUs (e.g., packets) for transmitting to the network node 104. Bearer managing component 112 can also manage the buffers 122 that correspond to the one or more bearers, as described further herein. It is to be appreciated that the radio bearers may include one or more signaling radio bearers, default radio bearers, dedicated radio bearers, etc. In another example, bearer managing component 112 may establish a best effort bearer with network node 104 for transmitting data at a best effort QoS, and the best effort bearer may have an associated best effort buffer 124. Thus, bearer managing component 112 may manage the best effort buffer 124 as well, as described further herein.

Method 200 further includes, at Block 204, mapping a plurality of PDUs from a buffer over the uplink resource grant in generating a transport block for transmitting data. Resource mapping component 114 can map the plurality of PDUs from the buffer 122 over the uplink resource grant in generating a transport block for transmitting data. For example, this can include resource mapping component 114 mapping the PDUs from the buffer 122 to a plurality of resource blocks of the uplink resource grant. This can occur at the packet data convergence protocol (PDCP)/radio link control (RLC) layer, for example, where RLC PDUs are built for mapping onto a resource blocks in a transport block of the uplink resource grant.

It is possible that after mapping the PDUs from buffer 122, that resource blocks of the uplink resource grant may still remain. For example, as described, in some instances, an uplink resource grant from network node 104 may include more resources than necessary to transmit the contents of buffer 122 (also referred to herein as a superfluous grant). This may occur, for example, where the network node 104 provides superfluous grants to the UE 102 in response to buffer status reporting from the UE 102, the network node 104 providing grants to the UE 102 over a period of time (even when a buffer status report is 0) to avoid a new scheduling request transmitted by the UE 102, the network node 104 continuously granting resources to the UE 102 where the UE 102 may not have data to transmit, the UE 102 discarding time critical upper layer data due to a delay in the grant provided to the UE 102 by the network node 104, etc. In any case, any remaining resources in the uplink grant can be used to transmit some best effort data.

Thus, method 200 also includes, at Block 206, determining that additional resources remain on the uplink resource grant after mapping the PDUs. Additional resource determining component 116 can determine that additional resource remain on the uplink resource grant after mapping the PDUs. For example, this may include, at Block 208, determining that a size of the uplink resource grant is greater than a size of data in the buffer. Additional resource determining component 116 can determine that the size of the uplink resource grant received by communicating component 110 is greater than the size of data in the buffer 122. In any case, to the extent additional resources are identified, the additional resource may be used for transmitting best effort data.

Accordingly, method 200 includes, at Block 210, mapping one or more additional PDUs for opportunistically transmitting data from a best effort buffer over the additional resources. Additional resource mapping component 118 may map the one or more additional PDUs for opportunistically transmitting data from the best effort buffer 124 over the additional resources. The best effort data can accordingly be opportunistically transmitted based on unused uplink resources in the uplink resource grant. For example, data in the best effort buffer 124 may include data such as synchronization or control data exchanged between UE 102 and network node 104 including voice/data call statistics, diagnostic messages, etc., non-critical best effort user datagram protocol (UDP) application layer data, and/or the like. In this regard, unused uplink resources can be used to send the best effort data from the best effort buffer 124 without utilizing an additional resource grant for the best effort data, which can conserve and improve utilization of the uplink resources. It is to be appreciated that bearer managing component 112 may provide higher layer applications with an option for storing data in the best effort buffer 124 for transmission using a best effort QoS.

Method 200 further includes, at Block 212, transmitting the plurality of PDUs and the one or more additional PDUs based on the uplink resource grant. Communicating component 110 can transmit the plurality of PDUs and the one or more additional PDUs based on the uplink resource grant as the PDUs mapped to the resources of the uplink resource grant. Network node 104 may receive the transmissions (e.g., via communicating component 130) for processing the PUDs and one or more additional PDUs corresponding to the radio bearer(s) and best effort bearer, respectively.

Method 200 may optionally include, at Block 214, transmitting a BSR to the network node indicating a status of the buffer. Buffer status reporting component 120 may transmit the BSR to the network node 104 indicating the status of the buffer 122. For example, this can include indicating a size of data in the buffer, a utilization of the buffer 122 (e.g., reflected as a percentage of the buffer utilized to store data), etc. to the network node 104. BSR receiving component 136 can obtain the BSR from the UE 102 and can accordingly determine an uplink resource grant for the UE 102 for communicating data from the buffer 122. This uplink resource grant may include additional resources, over which additional resource mapping component 118 can map PDUs from best effort buffer 124, as described. It is to be appreciated that where additional resource mapping component 118 is able to map best effort data over additional resources in uplink resource grants for other bearers, buffer status reporting component 120 need not report a buffer status for best effort buffer 124. Thus, for example, buffer status reporting component 120 may refrain from transmitting, to network node 104, a BSR for the best effort buffer 124.

Moreover, in an example, method 200 may optionally include, at Block 216, replacing data in the best effort buffer with newer data from one or more applications. For example, bearer managing component 112 may receive best effort data from higher layer applications, and can accordingly manage best effort buffer 124 as a first-in first-out buffer such to store the most current best effort data, and retain a size of the best effort buffer 124. It is to be appreciated that bearer managing component 112 may notify the higher layer applications where data expires and is removed from the buffer before transmission to allow the higher layer applications to handle this case. In addition, in an example, bearer managing component 112 may discard data from the best effort buffer 124 based on managing an associated discard timer 126. For example, the discard timer 126 may relate to a PDCP layer discard timer or another discard timer. For example, bearer managing component 112 can initialize the discard timer 126 when the data is stored in the best effort buffer 124. Based on determining expiration of the timer, bearer managing component 112 can discard or otherwise mark stale data associated with the discard timer 126, such that the bearer managing component 112 can replace data that is discarded or otherwise marked stale with new data from one or more applications in the best effort buffer 124.

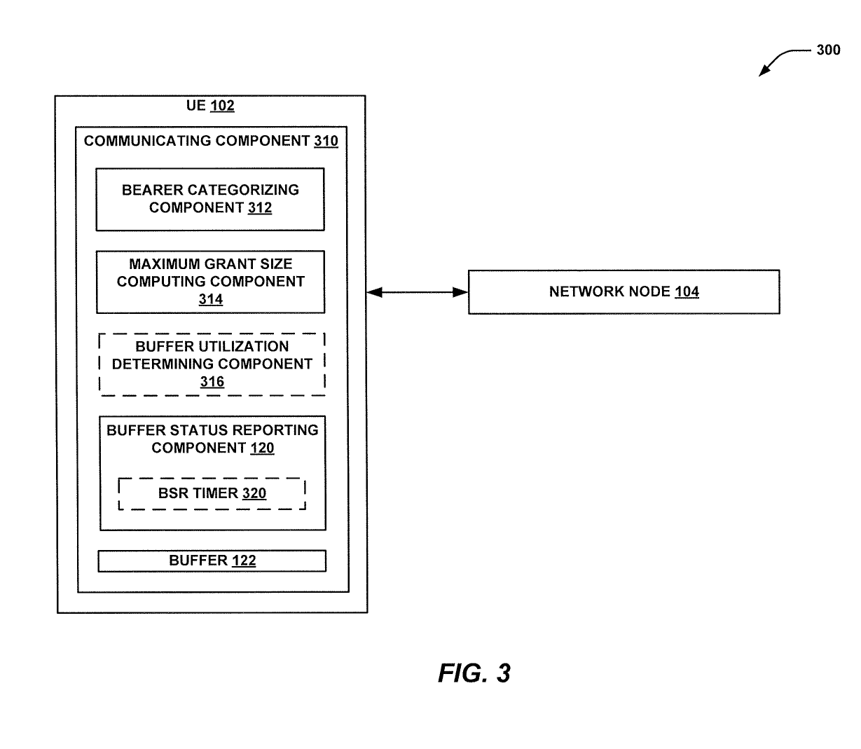

FIG. 3 is a schematic diagram illustrating a system 300 for wireless communication, according to an example configuration. FIG. 1 includes a UE 102 that receives resource grants from a network node 104 for communicating with the network node 104. Though one UE 102 and one network node 104 are shown, it is to be appreciated that multiple UEs 102 can communicate with a network node 104, a UE 102 can communicate with multiple network nodes 104, and/or the like. In addition, it is to be appreciated that UE 102 can be substantially any sort of network device that can receive resources for communicating with a network node 104. Similarly, network node 104 can be substantially any network node that generates resource grants for allowing one or more devices to communicate therewith, as described above.

UE 102 can include a communicating component 310 for managing communications with network node 104, which may include receiving resource grants from the network node 104 and communicating over the granted resources. Communicating component 310 can include a bearer categorizing component 312 for assigning a category to one or more bearers with a network node that may indicate a priority associated with the one or more bearers, a maximum grant size computing component 314 for computing a maximum possible grant size over the one or more bearers for communicating with the network node, an optional buffer utilization determining component 316 for determining a level of utilization of a buffer related to the one or more bearers, and a buffer status reporting component 120 for transmitting a BSR for the one or more bearers to the network node based at least in part on the priority and buffer utilization of a buffer 122 of the one or more bearers.

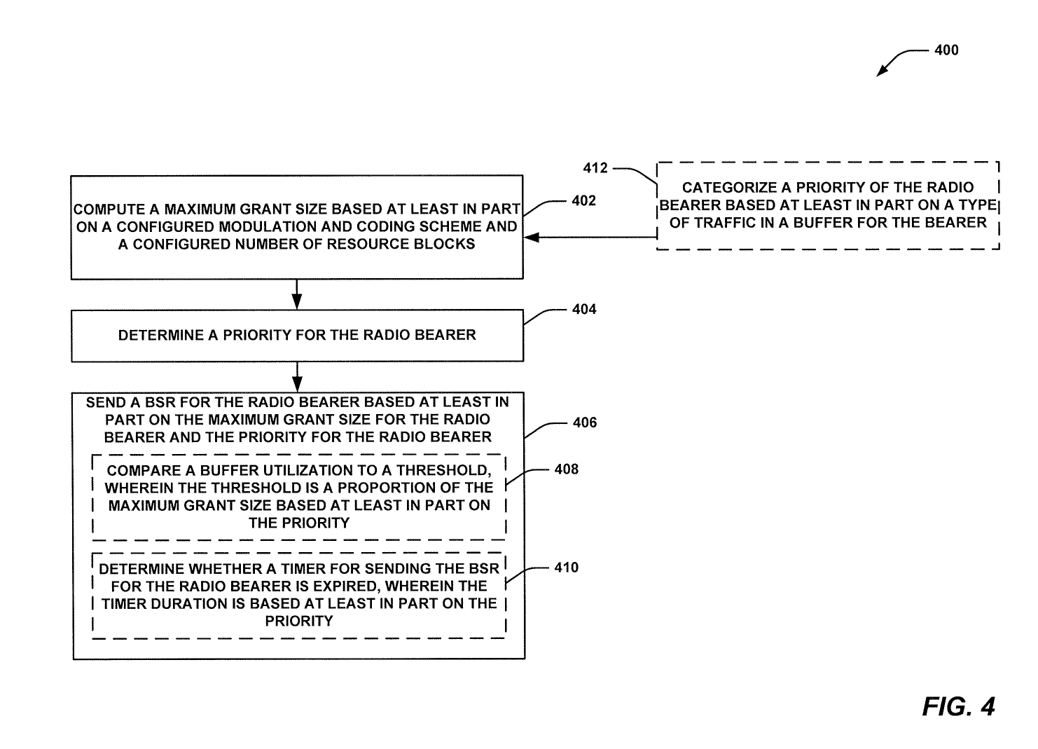

FIG. 4 illustrates a method 400 for improving buffer status reporting to avoid superfluous grants by a network node. Method 400 includes, at Block 402, computing a maximum grant size based at least in part on a configured modulation and coding scheme (MCS) and a configured number of resource blocks for communicating data for the radio bearer. Maximum grant size computing component 314 can compute the maximum grant size based at least in part on the configured MCS and the configured number of resource blocks for communicating data for the radio bearer. For example, communicating component 310 may select the MCS (e.g., based on a configuration received from the network node 104, based on detected radio conditions with the network node, etc.). The configured number of resource blocks can refer to a number of resource blocks granted to the UE 102 (e.g., in one or more previous or current grants received from the network node 104), and communicating component 310 may accordingly determine the number of resource blocks in this regard as well. For example, maximum grant size computing component 314 may accordingly determine the maximum grant size based on matching the MCS and number of resource blocks to one or more tables that provide a corresponding grant size for the MCS and number of resource blocks. Examples of such tables are provided in 3GPP Technical Specification 36.213, Version 12.4.0, Section 7.1.7.2.

Method 400 also includes, at Block 404, determining a priority for the radio bearer. Bearer categorizing component 312 can determine the priority for the radio bearer. In one example, method 400 optionally includes, at Block 412, categorizing a priority of the radio bearer based at least in part on a type of traffic in a buffer for the bearer. Bearer categorizing component 312 can categorize the priority of the radio bearer based on one or more parameters related to the radio bearer or corresponding buffer, such as a type of traffic in the buffer 122 for transmitting over the radio bearer, latency or QoS parameters defined for the radio bearer (e.g., lower latency or higher QoS can be of higher priority than higher latency or lower QoS, respectively), etc. For instance, the bearers can be prioritized into any number of priorities (e.g., high, medium, and low priority, 1 through n priority, where n is a positive integer, etc.). In any case, for example, bearer categorizing component 312 may determine the priority for the radio bearer based on the categorization related to the type of traffic.

Method 400 also includes, at Block 406, sending a BSR for the radio bearer based at least in part on the maximum grant size for the radio bearer and the priority for the radio bearer. Buffer status reporting component 120 can send the BSR for the radio bearer based at least in part on the maximum grant size for the radio bearer and the priority for the radio bearer. For example, for high priority radio bearers, buffer status reporting component 120 may send BSRs to the network node 104 any time there is data in the buffer 122. For other priority bearers, in an example, the buffer status reporting component 120 may delay reporting the BSR based at least in part on determining a buffer utilization of the bearers.

Thus, sending the BSR at Block 406 may include, at Block 408, comparing a buffer utilization to a threshold, wherein the threshold is a proportion of the maximum grant size based at least in part on the priority. Buffer status reporting component 120 can compare the buffer utilization to a threshold, wherein the threshold is a proportion of the maximum grant size based at least in part on the priority. For example, buffer status reporting component 120 can determine the threshold for the comparison based at least in part on the priority of the radio bearer. In one example, buffer status reporting component 120 can determine the threshold as ½ of a maximum grant size for a bearer having a medium priority. In another example, buffer status reporting component 120 can determine the threshold as the maximum grant size for a bearer having a low priority. It is to be appreciated that substantially any priority classifications and corresponding proportions can be used in determining the threshold. In any case, buffer utilization determining component 316 can determine the buffer utilization for the bearer as described above (e.g., as a proportion of a size of data in the buffer to the buffer size, etc.), and buffer status reporting component 120 determines whether to transmit the BSR based on comparing the buffer utilization to the threshold for the bearer.

In an additional or alternative example, sending the BSR at block 406 may include, at Block 410, determining whether a timer for sending the BSR for the radio bearer is expired, wherein the timer duration is based at least in part on the priority. Buffer status reporting component 120 can determine whether the timer (e.g., BSR timer 320) for sending the BSR for the radio bearer is expired, wherein the timer duration is based at least in part on the priority. For example, buffer status reporting component 120 may initialize a BSR timer 320 for each bearer (or at least each bearer that is not of a priority at which a BSR is sent when data is in the buffer 122). Buffer status reporting component 120 may initialize the BSR timer 320 using a duration that is based on the priority such that bearers of lower priority can have higher duration. Upon sending a BSR for a given bearer, buffer status reporting component 120 can reset an associated BSR timer 320 if available. This can ensure that data in the buffer 122 for a given radio bearer is sent at least after timer expiration regardless of the comparison of buffer capacity to the threshold.

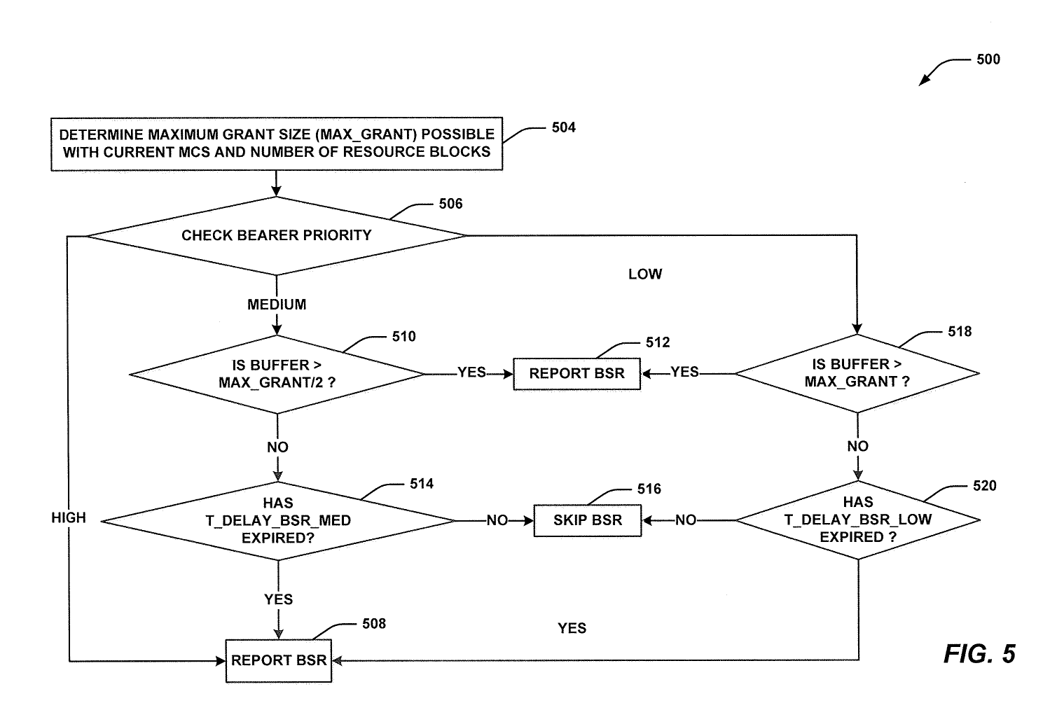

FIG. 5 illustrates a specific example of a method 500 for reporting BSR based on a bearer priority during a MAC BSR calculation. Method 500 includes, at Block 504, determining a maximum grant size (max_grant) possible with a current MCS and a number of resource blocks. As described, maximum grant size computing component 314 can determine the max_grant possible with the current MCS and the number of resource blocks. Method 500 includes, at Block 506, checking the bearer priority. As described, bearer categorizing component 312 can check the bearer priority based on a previously configured categorization for the bearer (e.g., based on a type of traffic sent over the bearer). If the bearer priority is high, BSR is reported at Block 508. As described, buffer status reporting component 120 can report the BSR of the buffer 122 related to the high priority bearer.

If the bearer priority is medium, it can be determined, at Block 510, whether the buffer capacity is greater than max_grant/2. If the buffer capacity is greater than max_grant/2, the BSR is reported at Block 512. As described, buffer status reporting component 120 can determine whether the buffer capacity is greater than max_grant/2 and can accordingly report BSR if so. If the buffer capacity is not greater than max_grant/2, it can be determined, at Block 514, whether a timer T_DELAY_BSR_MED has expired. If so, BRS can be reported at 508, and if not, BSR reporting is skipped at Block 516. As described, buffer status reporting component 120 can determine whether the buffer capacity the BSR timer 320, which can be the T_DELAY_BSR_MED, has expired, and if so can report BSR, or if not, can skip reporting the BSR.

If the bearer priority is low, it can be determined, at Block 510, whether the buffer capacity is greater than max_grant. If the buffer capacity is greater than max_grant, the BSR is reported at Block 512. As described, buffer status reporting component 120 can determine whether the buffer capacity is greater than max_grant and can accordingly report BSR if so. If the buffer capacity is not greater than max_grant, it can be determined, at Block 514, whether a timer T_DELAY_BSR_LOW has expired. If so, BRS can be reported at 508, and if not, BSR reporting is skipped at Block 516. As described, buffer status reporting component 120 can determine whether the buffer capacity the BSR timer 320, which can be the T_DELAY_BSR_LOW, has expired, and if so can report BSR, or if not, can skip reporting the BSR.

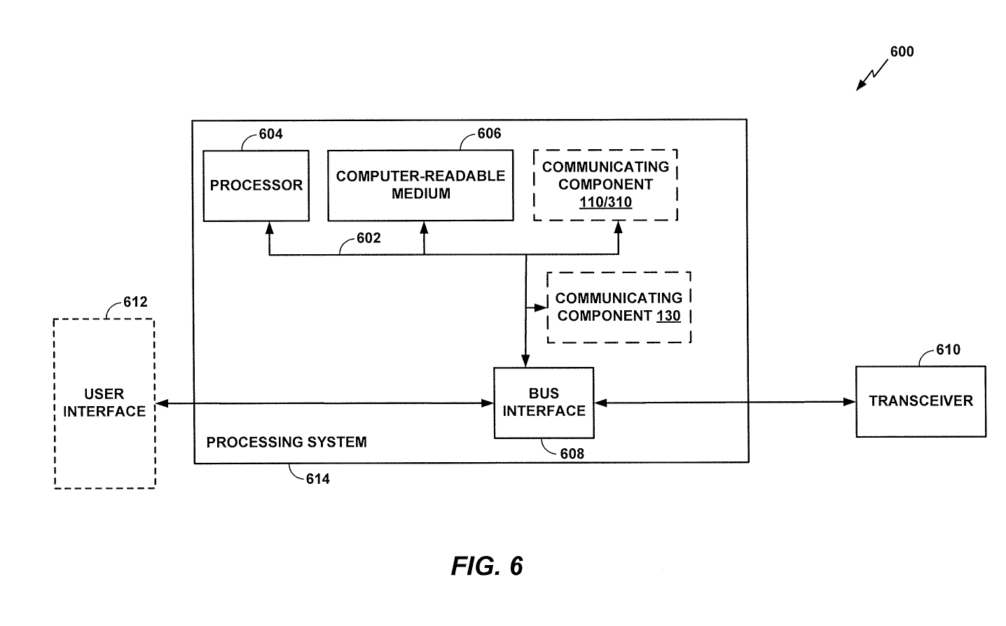

FIG. 6 is a conceptual diagram illustrating an example of a hardware implementation for an apparatus 600 employing a processing system 614. In some examples, the processing system 614 may comprise a UE, network node, etc., or a component of a UE (e.g., UE 102 of FIG. 1 or FIG. 3, etc.), a component of a network node 104 (e.g., network node 104 of FIG. 1 or FIG. 3, etc.). In this example, the processing system 614 may be implemented with a bus architecture, represented generally by the bus 602. The bus 602 may include any number of interconnecting buses and bridges depending on the specific application of the processing system 614 and the overall design constraints. The bus 602 links together various circuits including one or more processors, represented generally by the processor 604, computer-readable media, represented generally by the computer-readable medium 606, communicating component 110 and/or 310, communicating component 130, (FIGS. 1 and 3), components thereof, etc., which may be configured to carry out one or more methods or procedures described herein (e.g., method 200 (FIG. 2), method 400 (FIG. 4), method 500 (FIG. 5), etc.).

The bus 602 may also link various other circuits such as timing sources, peripherals, voltage regulators, and power management circuits, which are well known in the art. A bus interface 608 provides an interface between the bus 602 and a transceiver 610. The transceiver 610 provides a means for communicating with various other apparatus over a transmission medium. In an example, transceiver 610 can include or perform the functions of communicating component 110 and/or 310, communicating component 130 (FIGS. 1 and 3), etc. as described herein, including aspects described with respect to method 200 (FIG. 2), method 400 (FIG. 4), method 500 (FIG. 5), etc. Depending upon the nature of the apparatus, a user interface 612 (e.g., keypad, display, speaker, microphone, joystick) may also be provided.

The processor 604 is responsible for managing the bus 602 and general processing, including the execution of software stored on the computer-readable medium 606. The software, when executed by the processor 604, causes the processing system 614 to perform the various functions described infra for any particular apparatus. The computer-readable medium 606 may also be used for storing data that is manipulated by the processor 604 when executing software.

In an aspect, processor 604, computer-readable medium 606, or a combination of both may be configured or otherwise specially programmed to perform the functionality of the communicating component 110 and/or 310, communicating component 130, components thereof, or various other components described herein. For example, processor 604, computer-readable medium 606, or a combination of both may be configured or otherwise specially programmed to perform the functionality of communicating component 110, communicating component 130, components thereof, etc., described herein, and/or the like. Accordingly, in an example, processor 604 can perform the functions of bearer managing component 112, resource mapping component 114, additional resource determining component 116, additional resource mapping component 118, buffer status reporting component 120, bearer categorizing component 312, maximum grant size computing component 314, buffer utilization determining component 316, etc., which can include performing Blocks 202, 204, 206, 208, 210, 212, 214, and/or 216 of FIG. 2, Blocks 402, 404, 406, 408, 410, and/or 412 of FIG. 4, Blocks 504, 506, 508, 510, 512, 516, and/or 516 of FIG. 5, etc.

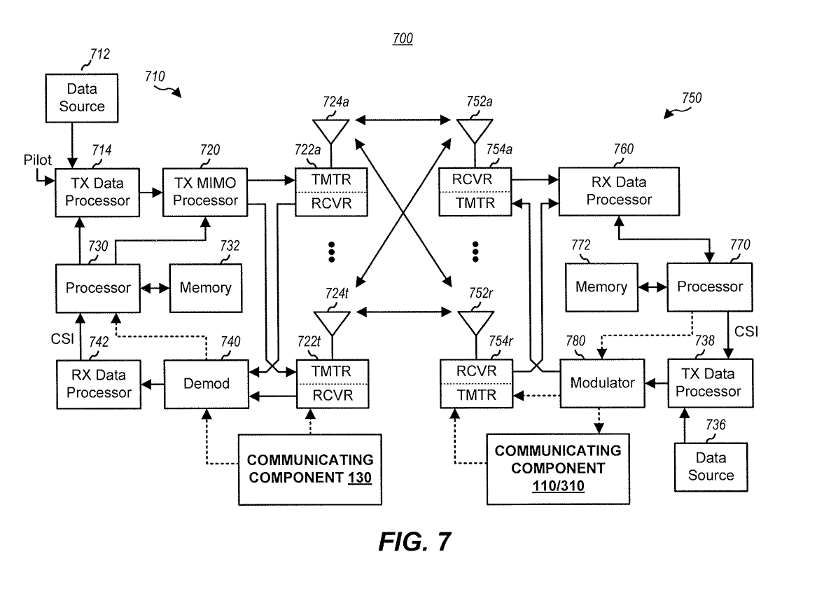

FIG. 7 is a block diagram of an embodiment of an eNB 710 and a UE 750 in a MIMO system 700. For example, eNB 710 may include a network node 104, and/or one or more components thereof, such as a communicating component 130 for granting uplink resources to a UE 750, as described herein. Similarly, UE 750 may include a UE 102, and/or one or more components thereof, such as a communicating component 110 and/or 130 for utilizing unused resource of an uplink grant for communicating best effort data to the eNB 710 and/or mitigating superfluous grants from the eNB 710 by managing buffer status reporting, as described herein. At the eNB 710, traffic data for a number of data streams is provided from a data source 712 to a transmit (TX) data processor 714.

In an embodiment, each data stream is transmitted over a respective transmit antenna. TX data processor 714 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 730.

The modulation symbols for all data streams are then provided to a TX MIMO processor 720, which may further process the modulation symbols (e.g., for OFDM). TX MIMO processor 720 then provides N_{T} modulation symbol streams to N_{T} transmitters (TMTR) 722a through 722t. In certain embodiments, TX MIMO processor 720 applies beamforming weights to the symbols of the data streams and to the antenna from which the symbol is being transmitted.

Each transmitter 722 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 722a through 722t are then transmitted from N_{T} antennas 724a through 724t, respectively.

At UE 750, the transmitted modulated signals are received by N_{R} antennas 752a through 752r and the received signal from each antenna 752 is provided to a respective receiver (RCVR) 754a through 754r. Each receiver 754 conditions (e.g., filters, amplifies, and downconverts) a respective received signal, digitizes the conditioned signal to provide samples, and further processes the samples to provide a corresponding “received” symbol stream.

An RX data processor 760 then receives and processes the N_{R} received symbol streams from N_{R} receivers 754 based on a particular receiver processing technique to provide N_{T} “detected” symbol streams. The RX data processor 760 then demodulates, deinterleaves, and decodes each detected symbol stream to recover the traffic data for the data stream. The processing by RX data processor 760 is complementary to that performed by TX MIMO processor 720 and TX data processor 714 at eNB 710.

A processor 770 periodically determines which pre-coding matrix to use (discussed below). Processor 770 formulates a reverse link message comprising a matrix index portion and a rank value portion.

The reverse link message may comprise various types of information regarding the communication link and/or the received data stream. The reverse link message is then processed by a TX data processor 738, which also receives traffic data for a number of data streams from a data source 736, modulated by a modulator 780, conditioned by transmitters 754a through 754r, and transmitted back to eNB 710.

At eNB 710, the modulated signals from UE 750 are received by antennas 724, conditioned by receivers 722, demodulated by a demodulator 740, and processed by a RX data processor 742 to extract the reserve link message transmitted by the UE 750. Processor 730 then determines which pre-coding matrix to use for determining the beamforming weights then processes the extracted message.

Several aspects of a telecommunications system have been presented with reference to a W-CDMA system. As those skilled in the art will readily appreciate, various aspects described herein may be extended to other telecommunication systems, network architectures and communication standards.

By way of example, various aspects described herein may be extended to other UMTS systems such as W-CDMA, TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects described herein, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described herein. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the functionality described herein depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods or methodologies described herein may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described herein that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f) unless the element is expressly recited using the phrase “means for” or, in the case of a method claim, the element is recited using the phrase “step for.”

What is claimed is:

1. A method for utilizing available space in an uplink resource grant, comprising:
receiving an uplink resource grant from a network node;
mapping a plurality of protocol data units from a buffer over the uplink resource grant in generating a transport block for transmitting data;
determining that additional resources remain on the uplink resource grant after mapping the plurality of protocol data units;
mapping one or more additional protocol data units for opportunistically transmitting data from a best effort buffer over the additional resources; and
transmitting the plurality of protocol data units and the one or more additional protocol data units based on the uplink resource grant.

2. The method of claim 1, further comprising establishing a best effort radio bearer with the network node, wherein the best effort buffer relates to the best effort radio bearer and the buffer relates to another radio bearer.

3. The method of claim 1, further comprising:
transmitting a buffer status report to the network node indicating a status of the buffer; and
refraining from transmitting a best effort buffer status report to the network node that indicates a status of the best effort buffer.

4. The method of claim 1, further comprising replacing data in the best effort buffer with newer data from one or more applications to retain a size of the best effort buffer.

5. The method of claim 4, wherein replacing the data is based at least in part on determining expiration of a discard timer.

6. The method of claim 1, wherein determining the additional resources comprises determining that a size of the uplink resource grant is greater than a size of data in the buffer.

7. An apparatus for utilizing available space in an uplink resource grant, comprising:
a communicating component configured to receive an uplink resource grant from a network node;
a resource mapping component configured to map a plurality of protocol data units from a buffer over the uplink resource grant in generating a transport block for transmitting data;
an additional resource determining component configured to determine that additional resources remain on the uplink resource grant after mapping the plurality of protocol data units; and
an additional resource mapping component configured to map one or more additional protocol data units for opportunistically transmitting data from a best effort buffer over the additional resources,
wherein the communicating component is further configured to transmit the plurality of protocol data units and the one or more additional protocol data units based on the uplink resource grant.

8. The apparatus of claim 7, further comprising a bearer managing component configured to establish a best effort radio bearer with the network node, wherein the best effort buffer relates to the best effort radio bearer and the buffer relates to another radio bearer.

9. The apparatus of claim 7, further comprising a buffer status reporting component configured to transmit a buffer status report to the network node indicating a status of the buffer, and refrain from transmitting a best effort buffer status report to the network node that indicates a status of the best effort buffer.

10. The apparatus of claim 7, further comprising a bearer managing component configured to replace data in the best effort buffer with newer data from one or more applications to retain a size of the best effort buffer.

11. The apparatus of claim 10, wherein the bearer managing component is configured to replace the data is based at least in part on determining expiration of a discard timer.

12. The apparatus of claim 7, wherein the additional resource determining component is configured to determine the additional resources based at least in part on determining that a size of the uplink resource grant is greater than a size of data in the buffer.

13. A method for sending buffer status reports (BSR) in wireless communications, comprising:
computing a maximum grant size for a user equipment (UE) based at least in part on a modulation and coding scheme and a number of resource blocks configured for the UE;
determining a priority for a radio bearer; and
sending a BSR for the radio bearer based at least in part on the maximum grant size and the priority for the radio bearer.

14. The method of claim 13, wherein sending the BSR is based at least in part on comparing a buffer utilization to a threshold, wherein the threshold is a proportion of the maximum grant size based at least in part on the priority.

15. The method of claim 14, wherein sending the BSR is further based at least in part on determining whether a timer for sending the BSR for the radio bearer is expired, wherein a duration of the timer is based at least in part on the priority.

16. The method of claim 13, further comprising categorizing the priority of the radio bearer as a high priority, a medium priority, or a low priority based at least in part on a type of traffic sent over the radio bearer.

17. The method of claim 16, wherein the priority is the high priority, and sending the BSR comprises sending the BSR based on determining data in a buffer for the radio bearer.

18. The method of claim 16, wherein the priority is the medium priority or the low priority, and sending the BSR comprises delaying sending of the BSR until a buffer utilization of a buffer for the radio bearer achieves a threshold, wherein the threshold is configured based at least in part on the priority.

19. The method of claim 18, wherein the priority is the medium priority, and the threshold is one half of the maximum grant size.

20. The method of claim 18, wherein the priority is the low priority, and the threshold is the maximum grant size.

21. The method of claim 16, wherein the priority is the medium priority or the low priority, and sending the BSR comprises delaying sending of the BSR until a timer expires, wherein a duration of the timer is configured based at least in part on the priority.

22. An apparatus for sending buffer status reports (BSR) in wireless communications, comprising:
a maximum grant size computing component configured to compute a maximum grant size for a user equipment (UE) based at least in part on a modulation and coding scheme and a number of resource blocks configured for the UE;
a bearer categorizing component configured to determine a priority for a radio bearer; and
a buffer status reporting component configured to send a BSR for the radio bearer based at least in part on the maximum grant size and the priority for the radio bearer.

23. The apparatus of claim 22, wherein the buffer status reporting component is configured to send the BSR based at least in part on comparing a buffer utilization to a threshold, wherein the threshold is a proportion of the maximum grant size based at least in part on the priority.

24. The apparatus of claim 23, wherein the buffer status reporting component is configured to send the BSR further based at least in part on determining whether a timer for sending the BSR for the radio bearer is expired, wherein a duration of the timer is based at least in part on the priority.

25. The apparatus of claim 22, wherein the bearer categorizing component is further configured to categorize the priority of the radio bearer as a high priority, a medium priority, or a low priority based at least in part on a type of traffic sent over the radio bearer.

26. The apparatus of claim 25, wherein the priority is the high priority, and wherein the buffer status reporting component is configured to send the BSR based on determining data in a buffer for the radio bearer.

27. The apparatus of claim 25, wherein the priority is the medium priority or the low priority, and wherein the buffer status reporting component is configured to delay sending of the BSR until a buffer utilization of a buffer for the radio bearer achieves a threshold, wherein the threshold is configured based at least in part on the priority.

28. The apparatus of claim 27, wherein the priority is the medium priority, and the threshold is one half of the maximum grant size.

29. The apparatus of claim 27, wherein the priority is the low priority, and the threshold is the maximum grant size.

30. The apparatus of claim 25, wherein the priority is the medium priority or the low priority, and wherein the buffer status reporting component is configured to delay sending of the BSR until a timer expires, wherein a duration of the timer is configured based at least in part on the priority.
